(19) United States
(12) Patent Application Publication
(10) Pub. No.: US 2014/0254442 A1
(43) Pub. Date: Sep. 11, 2014

(54) GSM TONE DETECTION

(71) Applicant: QUALCOMM INCORPORATED, San Diego, CA (US)

(72) Inventors: Ming Yang, San Diego, CA (US); Tom Chin, San Diego, CA (US)

(73) Assignee: QUALCOMM Incorporated, San Diego, CA (US)

(21) Appl. No.: 13/787,307

(22) Filed: Mar. 6, 2013

(51) Int. Cl. H04W 52/02

(52) U.S. Cl. CPC H04W 52/0229
USPC 370/311

(57) ABSTRACT

A method for tone detection includes wireless communicating on a first radio access technology (RAT). A determination is made of whether a gap generated by at least one idle timeslot in the first RAT communications is sufficient to perform tone detection but not sufficient to perform base station identity code (BSIC) verification of a second RAT. The halting of the performance of tone detection of the second RAT is made when the gap is not sufficient to perform BSIC verification.

### BACKGROUND

1. Field

Aspects of the present disclosure relate generally to wireless communication systems, and more particularly, to an improved method of GSM tone detection in circuit switched operation to reduce mobile device battery consumption.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method for wireless communication is disclosed. The method includes communicating on a first radio access technology (RAT). A UE determines whether a gap generated by idle timeslot(s) in the first RAT communications is sufficient to perform tone detection but not sufficient to perform base station identity code (BSIC) verification of a second RAT. The UE halts from performing tone detection of the second RAT is made when the gap is not sufficient to perform BSIC verification and when the signal quality of the serving cell of the first RAT is above a first threshold value.

Another aspect discloses an apparatus for wireless communication having a memory and at least one processor coupled to the memory. The processor(s) is configured to communicate on a first radio access technology (RAT). The processor(s) is also configured to determine whether a gap generated by an idle timeslot(s) in the first RAT communications is sufficient to perform tone detection but not sufficient to perform base station identity code (BSIC) verification of a second RAT. Further, the processor(s) is configured to halt the performance of tone detection of the second RAT, when the gap is not sufficient to perform BSIC verification and when the signal quality of the serving cell of the first RAT is above a first threshold value.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of communicating on a first radio access technology (RAT). The processor(s) is also configured to determine whether a gap generated by an idle timeslot(s) in the first RAT communications is sufficient to perform tone detection but not sufficient to perform base station identity code (BSIC) verification of a second RAT. Further, the processor(s) is configured to halt the performance of tone detection of the second RAT, when the gap is not sufficient to perform BSIC verification and when the signal quality of the serving cell of the first RAT is above a first threshold value.

Another aspect discloses an apparatus for wireless communication and includes means for communicating on a first radio access technology (RAT). The apparatus also includes means for determining whether a gap generated by an idle timeslot(s) in the first RAT communications is sufficient to perform tone detection but not sufficient to perform base station identity code (BSIC) verification of a second RAT. The apparatus also includes means for halting performance of tone detection of the second RAT, when the gap is not sufficient to perform BSIC verification and when the signal quality of the serving cell of the first RAT is above a first threshold value.

In another aspect, a method of wireless communications is disclosed. The method includes communicating on a first radio access technology (RAT). A determination is made of whether a gap generated by an idle timeslot(s) in the first RAT communications is sufficient to perform tone detection but not sufficient to perform base station identity code (BSIC) verification of a second RAT. Tone detection is performed to locate a signal from the second RAT for BSIC verification when the gap is not sufficient to perform BSIC verification and when the signal quality of the serving cell of the first RAT is below a first threshold value. Timeslots of the first RAT are selected based on timing of the signal from the second RAT for BSIC verification. Communications with the first RAT are halted during the selected timeslots. BSIC verification of the second RAT is performed during the selected timeslots.

Another aspect discloses an apparatus for wireless communication having a memory and at least one processor coupled to the memory. The processor(s) is configured to communicate on a first radio access technology (RAT). The processor(s) is also configured to determine whether a gap generated by an idle timeslot(s) in the first RAT communications is sufficient to perform tone detection but not sufficient to perform base station identity code (BSIC) verification of a second RAT. Further, the processor(s) is configured to perform tone detection to locate a signal from the second RAT for BSIC verification when the gap is not sufficient to perform BSIC verification and when the signal quality of the serving cell of the first RAT is below a first threshold value. The processor(s) is configured to select timeslots of the first RAT based on timing of the signal from the second RAT for BSIC verification. The processor(s) is also configured to halt communications with the first RAT during the selected timeslots. The processor(s) is further configured to perform verification of the second RAT during the selected timeslots.

Another aspect discloses a computer program product for wireless communications in a wireless network having a non-transitory computer-readable medium. The computer readable medium has non-transitory program code recorded thereon which, when executed by the processor(s), causes the processor(s) to perform operations of communicating on a first radio access technology (RAT). The processor(s) is also configured to determine whether a gap generated by an idle timeslot(s) in the first RAT communications is sufficient to perform tone detection but not sufficient to perform base station identity code (BSIC) verification of a second RAT. Further, the processor(s) is configured to perform tone detection to locate a signal from the second RAT for BSIC verification when the gap is not sufficient to perform BSIC verification and when the signal quality of the serving cell of the first RAT is below a first threshold value. The processor(s) is configured to select timeslots of the first RAT based on timing of the signal from the second RAT for BSIC verification. The processor(s) is also configured to halt communications with the first RAT during the selected timeslots. The processor(s) is further configured to perform verification of the second RAT during the selected timeslots.

In another aspect, an apparatus for wireless communication is disclosed that includes means for communicating on a first radio access technology (RAT). The apparatus also includes means for determining whether a gap generated by an idle timeslot(s) in the first RAT communications is sufficient to perform tone detection but not sufficient to perform base station identity code (BSIC) verification of a second RAT. The apparatus also includes means for performing tone detection to locate a signal from the second RAT for BSIC verification, when the gap is not sufficient to perform BSIC verification and when the signal quality of the serving cell of the first RAT is below a first threshold value. The apparatus also includes means for selecting timeslots of the first RAT based on timing of the signal from the second RAT for BSIC verification. The apparatus also includes means for halting communications with the first RAT during the selected timeslots. The apparatus further includes means for performing verification of the second RAT during the selected timeslots.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a GSM frame cycle.

FIG. 6 is a call flow diagram illustrating IRAT measurement according to one aspect of the present disclosure.

FIGS. 7A-7C are block diagrams illustrating examples of IRAT measurement according to the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

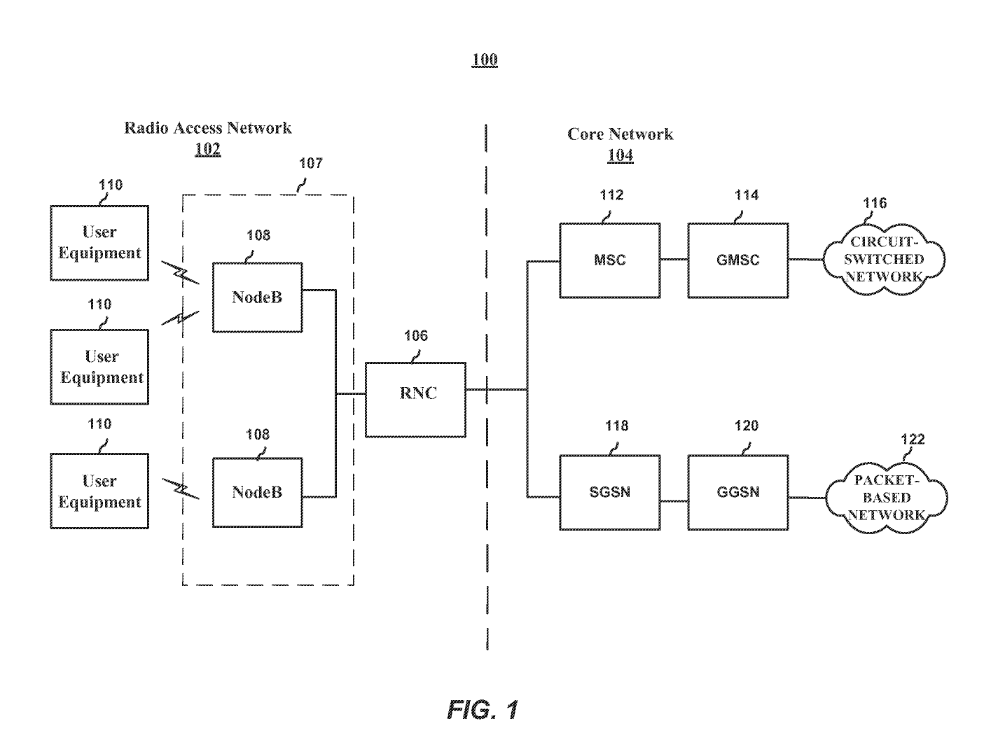

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

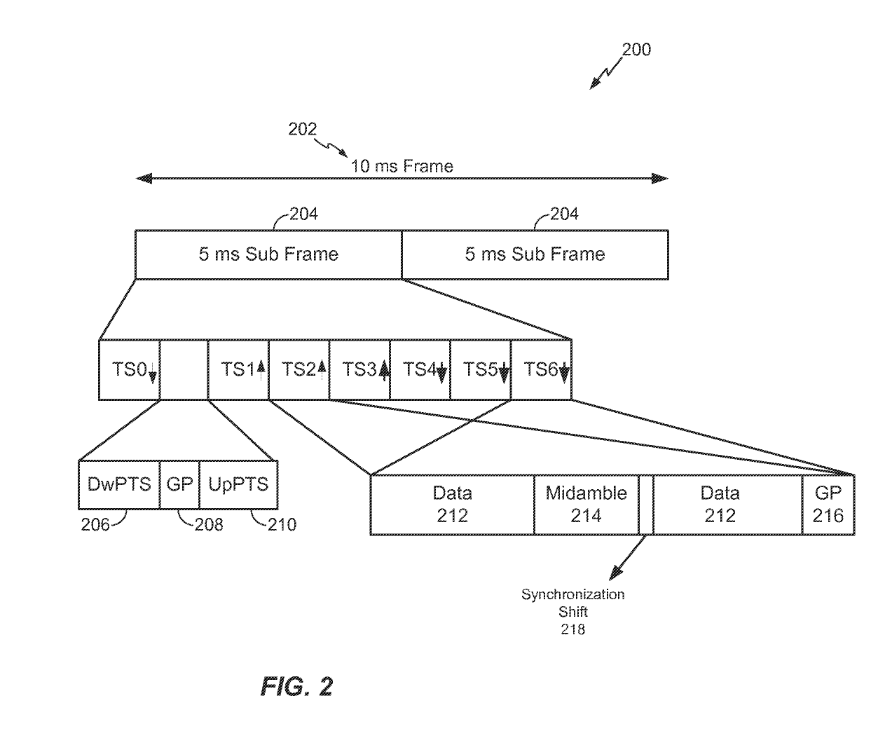

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

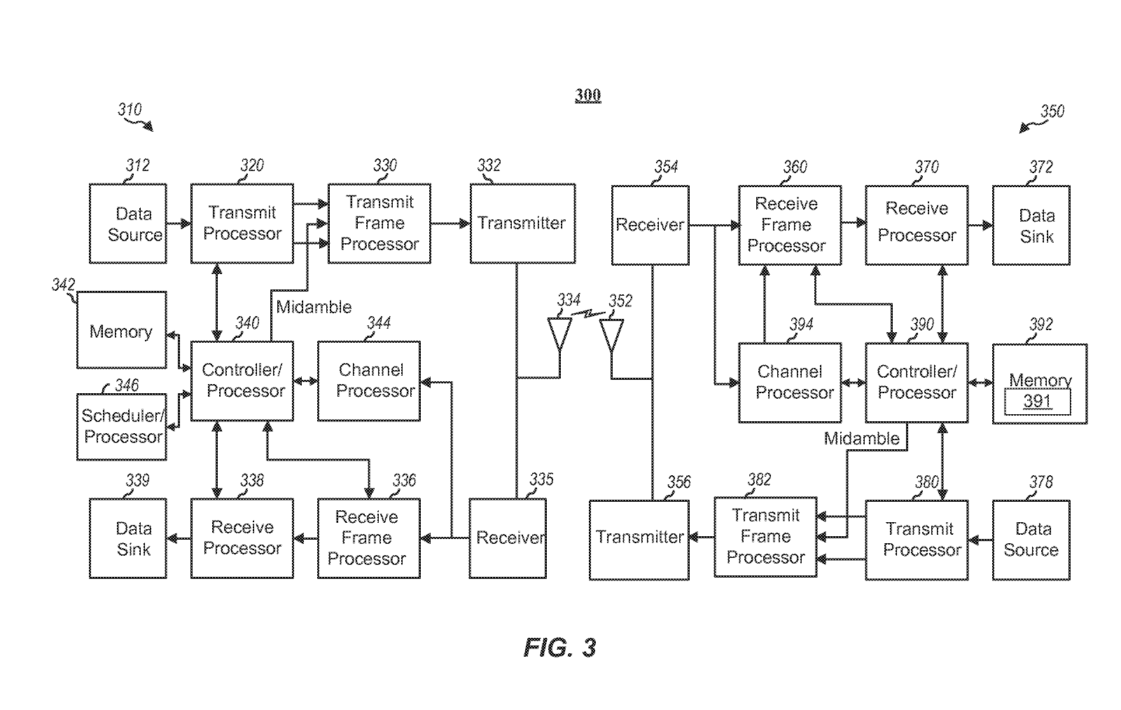

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a tone detection module 391 which, when executed by the controller/processor 390, configures the UE 350 for halting or performing tone detection under certain conditions.

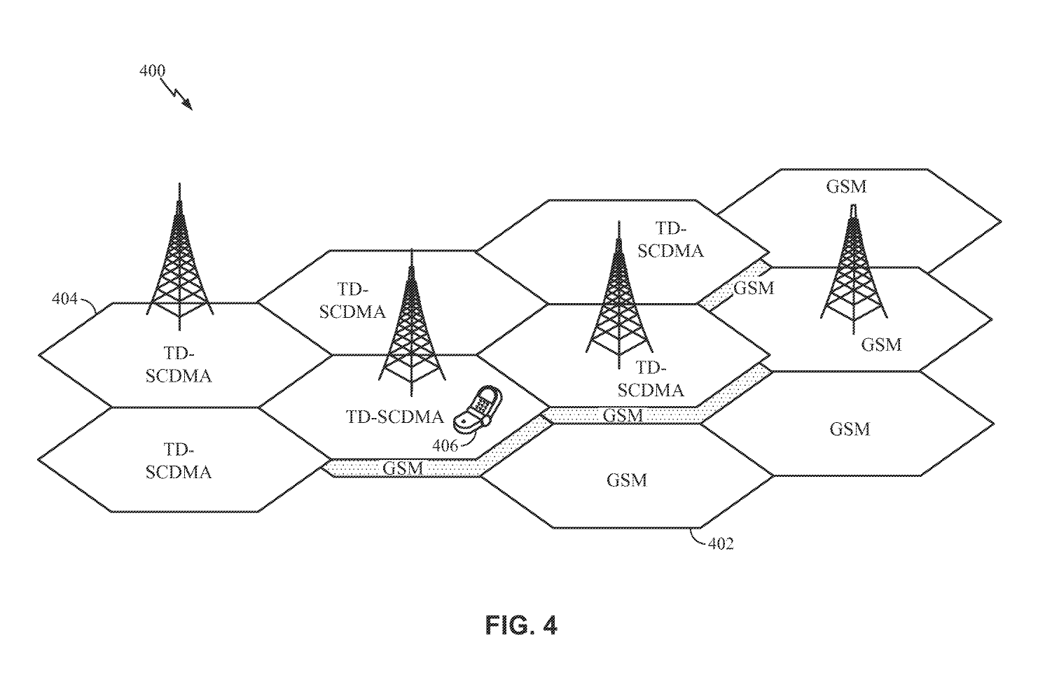

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

During the handover process the UE tunes to the GSM channel to acquire information from the GSM network. Because the available TD-SCDMA continuous time slots are limited (for example, only two or three continuous timeslots are typically available in a radio frame), the UE has limited time to measure the GSM cells and cannot complete a full measurement during a single set of continuous time slots. Thus, a portion of the measurement occurs during the first set of continuous time slots, a further portion of the measurement occurs during the available set of continuous time slots in the next cycle, etc., until enough time was provided to complete the measurement. Consequently, a slower than desired TD-SCDMA to GSM handover occurs.

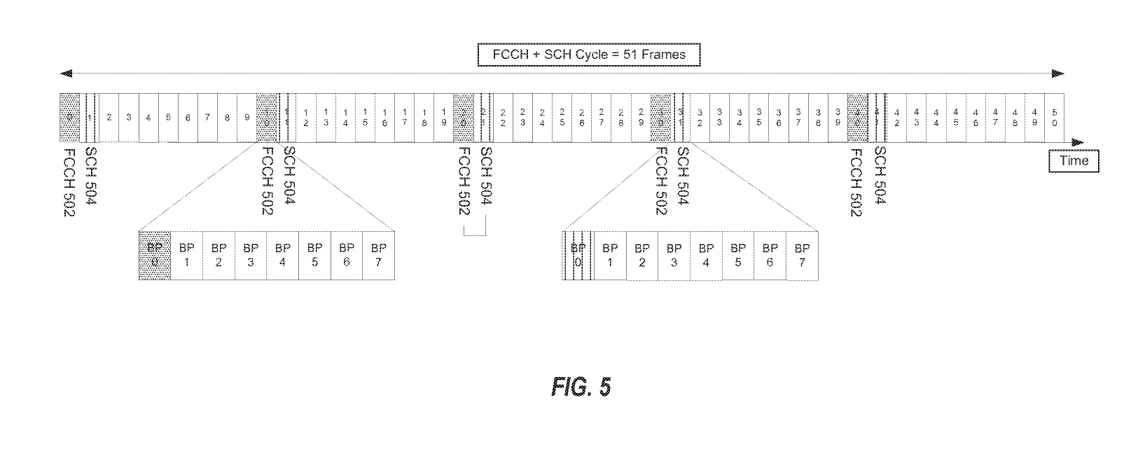

FIG. 5 is a block diagram illustrating a GSM frame cycle. The GSM frame cycle for the frequency correction channel (FCCH) 502 and synchronization channel (SCH) 504 consists of 51 frames, each of 8 burst periods (BPs). The FCCH 502 is in the first burst period (or BP 0) of frame 0, 10, 20, 30, 40, and the SCH 504 is in the first burst period of frame 1, 11, 21, 31, 41. A single burst period is 15/26 ms and a single frame is 120/26 ms. As shown in FIG. 5, the FCCH period is 10 frames (46.15 ms) or 11 frames (51.77 ms). Also as shown, the SCH period is 10 frames or 11 frames.

### Intelligent GSM Tone Detection

A user equipment connected to a TD-SCDMA network may handover to another network, such as a GERAN (GSM EDGE Radio Access Network), for a number of reasons. A UE may reach the coverage boundary of the TD-CDMA network and may handover to another network, such as GSM, to avoid a call drop. For example, UE 406 moving from the coverage area of TD-SCDMA cell 404, to the coverage area of GSM cell 402. A UE may also handover from TD-SCDMA to GSM in the event the UE encounters a coverage hole in the TD-SCDMA network. A UE may also handover to balance traffic between the TD-SCDMA network and GSM/GPRS (General Packet Radio Service)

TD-SCDMA to GERAN Inter-Radio Access Technology (IRAT) handover is typically based on event 3A measurement reporting. Event 3A triggering is based on the comparison between GSM and a TD-SCDMA filtered measurement. The measurement may include the following four items.

The measurement may include measuring the received signal code power (RSCP) of the TD-SCDMA serving cell primary common control physical channel (PCCPCH) and comparing that measurement to the TD-SCDMA system's own threshold (which may be known as “thresholdOwnSystem”) to determine if the TD-SCDMA signal is too weak to continue the TD-SCDMA connection. The value of thresholdOwnSystem is indicated to the UE through a dedicated radio resource control (RRC) signaling from the TD-SCDMA network.

The measurement may also include measuring the GSM received signal strength indication (RSSI) and comparing that measurement to an “other system” threshold (which may be known as “thresholdOtherSystem”) to determine if the GSM signal is sufficiently strong to perform the handover.

The measurement may also include confirmation of the GSM cell base station identity code (BSIC) and re-confirmation of the GSM BSIC re-confirm.

Once the UE performs the above measurements, the UE sends a measurement report event 3A. The measurement report event 3A triggers the UE handover from TD-SCDMA to GSM when the TD-SCDMA serving cell RSCP is below the predefined thresholdOwnSystem value, the target GSM cell RSSI is above the thresholdOtherSystem value, and the GSM cell is identified and reconfirmed (if it is requested by the network).

In present TD-SCDMA communications, a UE uses m (for example, m=2) idle time slots to perform GSM FCCH tone detection, and n (for example, n=3) time slots for SCH (synchronization channel) BSIC conformation and reconfirmation. The variable m may be less than n because measurement of the SCH BSIC may use more idle time slots. For release 4 (R4) DPCH (dedicated physical channel) non high-speed data calls, time slots are configured by radio resource control (RRC) signaling messages, and idle time slots are static.

In such R4 DPCH data calls, the UE only has sufficient idle time slots to perform FCCH (frequency correction channel) tone detection, and does not have sufficient idle time slots to perform a SCH BSIC procedure. However, even when the UE does not have sufficient idle time slots for a SCH BSIC procedure, the UE may continue to tune to different GSM frequencies and perform FCCH tone detection. In this scenario, the FCCH tone detection wastes the UE battery and communication resources, as the UE will not be able to complete a handover without having sufficient idle time slots to perform the SCH BSIC procedure.

Various aspects of the present disclosure are directed to reducing battery wasting communications. In one aspect, when the UE is in a R4 DCH CS (circuit switched) voice or data call, and the UE is configured with sufficient idle time slots for FCCH tone detection, but insufficient idle time slots for SCH BSIC, then the following applies. The UE IRAT measurement module, after receiving the RRC module indication, does not schedule the FCCH done detection and the layer 1 module does not tune to the various frequencies to perform the FCCH tone detection. This saves the UE battery power and reduces battery waste.

In another aspect, when the UE does not have sufficient idle time slots for a GSM BSIC verification procedure, the UE may create idle time slots by halting TD-SCDMA communications during certain time slots and performing BSIC verification during the time slots in which the TD-SCDMA communications were halted. The UE may select these TD-SCDMA time slots based on timing of the GSM signal, which the UE determines by performing the FCCH tone detection. That is the UE may choose the TD-SCDMA time lots that overlap with the GSM time slots which carry the signals to perform the BSIC verification.

In another aspect, when the UE does not have sufficient idle time slots for a GSM BSIC verification procedure, the UE may report to a base station (such as a TD-SCDMA RNC) that the UE has confirmed the BSIC, when it actually hasn't. The UE may then perform a blind handover to the GSM network and then confirm the BSC once connected to the GSM network.

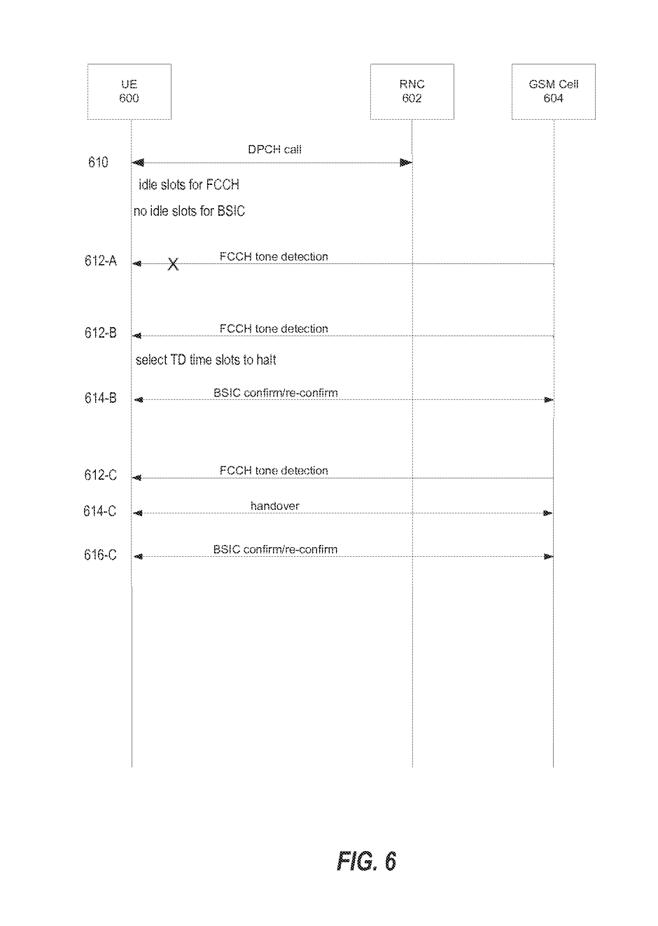

FIG. 6 illustrates a call flow according to one aspect of the present disclosure. A UE 600 is engaged in an ongoing dedicated physical channel (DPCH) call with a TD-SCDMA RNC 602 at time 610. As part of the call, the TD-SCDMA cell 602 attempts to perform measurements for handover to the GSM cell 604. During the call 610, the UE determines that it has sufficient idle time slots for FCCH tone detection, but insufficient idle time slots to perform a BSIC confirm/reconfirm procedure. The UE may perform one of three actions. First, at time 612-A, the UE may halt the FCCH tone detection it may have otherwise scheduled. Second, at time 612-B, the UE may perform FCCH tone detection, then determine the GSM timing based on that detection, then select TD-SCDMA time slots to turn idle by halting communications, and then at time 614-B, perform a BSIC confirm/reconfirm procedure using the selected time slots. Or, third, at time 612-C the UE may perform FCCH tone detection, at time 614-C the UE may perform handover to the GSM cell 604, and at time 616-C the UE may perform the BSIC confirm/reconfirm procedure while connected to the GSM cell 604.

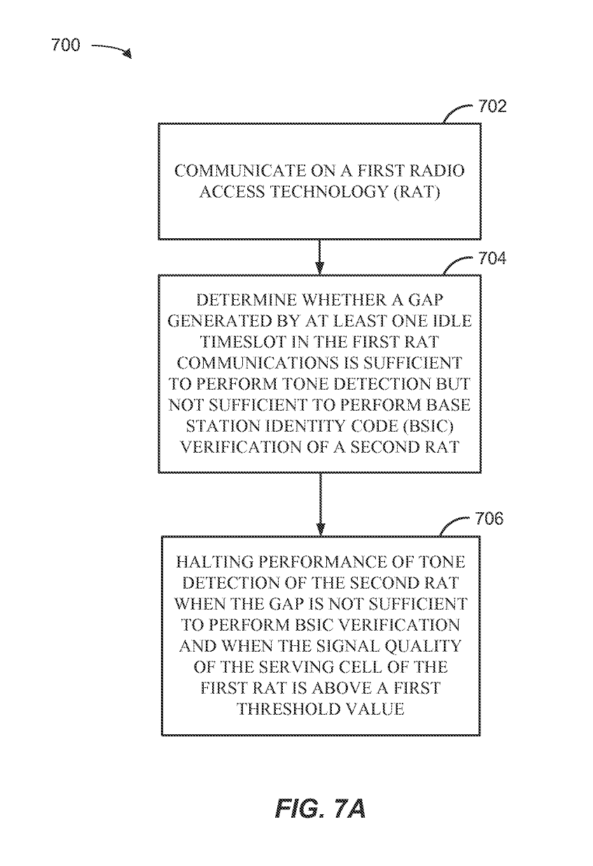

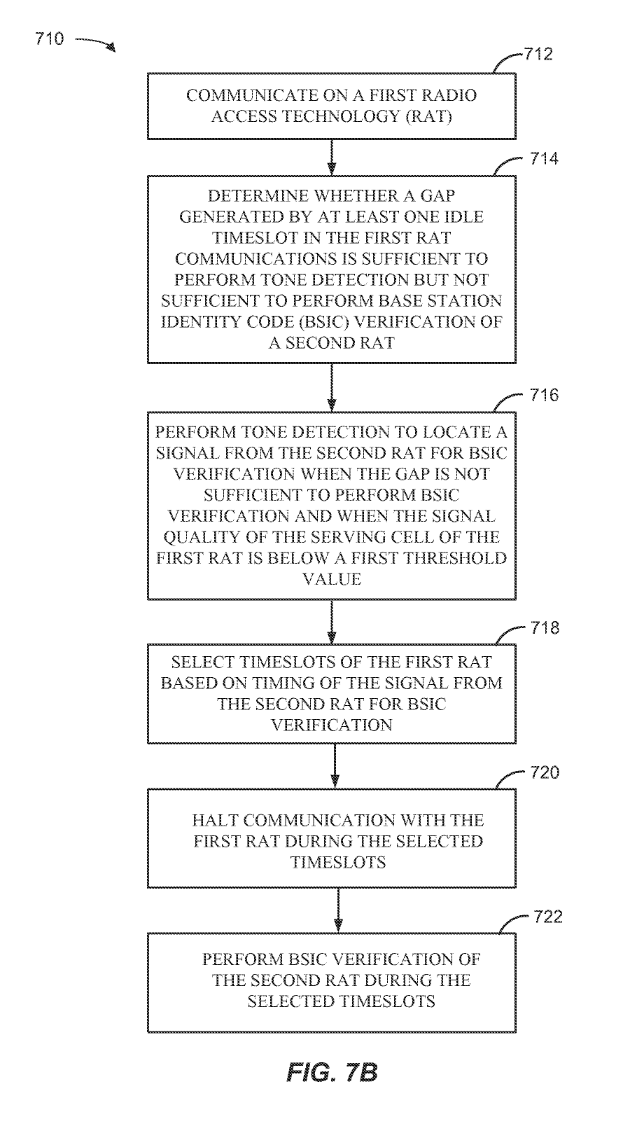

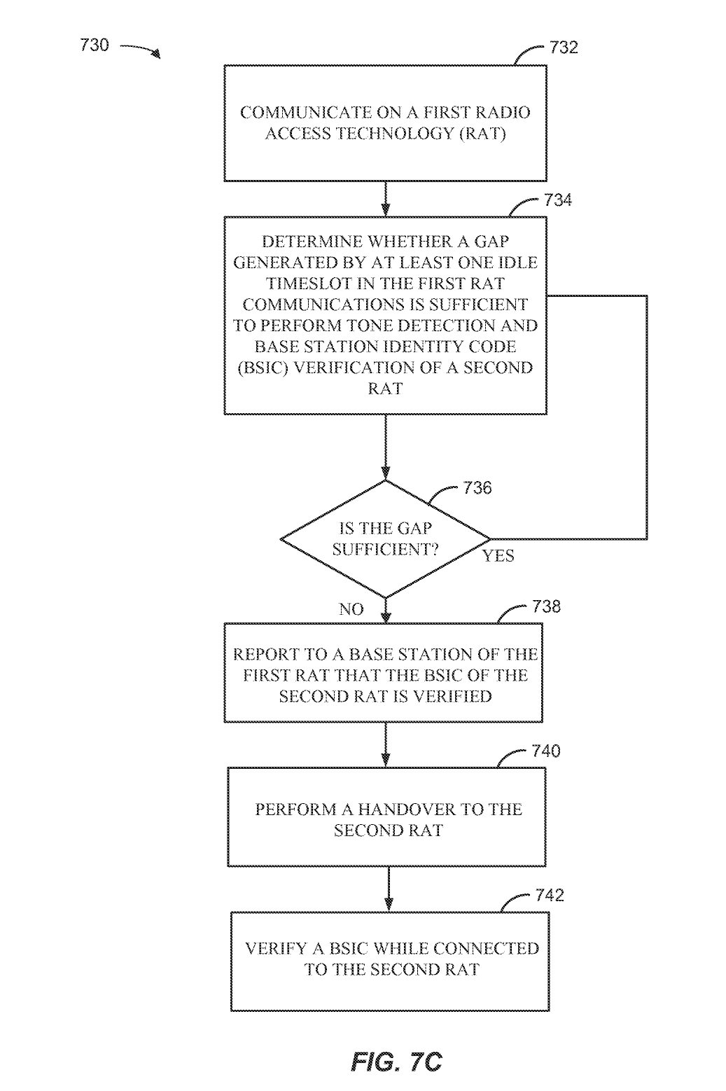

FIG. 7A shows a wireless communication method 700 according to one aspect of the disclosure. In block 702, a UE may communicate on a first radio access technology (RAT). In block 704, the UE determines whether a gap generated by at least one idle timeslot in the first RAT communications is sufficient to perform tone detection but not sufficient to perform base station identity code (BSIC) verification of a second RAT. In block 706, the UE halts performance of tone detection of the second RAT when the gap is not sufficient to perform BSIC verification and when the signal quality of the serving cell of the first RAT is above a first threshold value. In one aspect, the signal quality comprises a signal strength quality.

FIG. 7B shows a wireless communication method 710 according to one aspect of the disclosure. In block 712, a UE may communicate on a first RAT. In block 714, the UE determines whether a gap generated by at least one idle timeslot in the first RAT communications is sufficient to perform tone detection but not sufficient to perform BSIC verification of a second RAT. In block 716, the UE may perform tone detection to locate a signal from the second RAT for BSIC verification when the gap is not sufficient to perform BSIC verification and when the signal quality of the serving cell of the first RAT is below a first threshold value. In block 718, the UE may select timeslots of the first RAT based on timing of the signal from the second RAT for BSIC verification. In block 720, the UE may halt communication with the first RAT during the selected timeslots. In block 722, the UE may perform BSIC verification of the second RAT during the selected timeslots.

FIG. 7C shows a wireless communication method 730 according to one aspect of the disclosure. In block 732, a UE may communicate on a first RAT. In block 734, the UE determines whether a gap generated by at least one idle timeslot in the first RAT communication is sufficient to perform tone detection and BSIC verification of a second RAT. In block 736, the question is asked of whether the gap is sufficient. If yes, the method goes back to block 734. If no, then the method goes to block 738, where the UE may report to a base station of the first RAT that the BSIC of the second RAT is verified. In block 740, the UE may perform a handover to the second RAT. In block 742, the UE may verify a BSIC while connected to the second RAT.

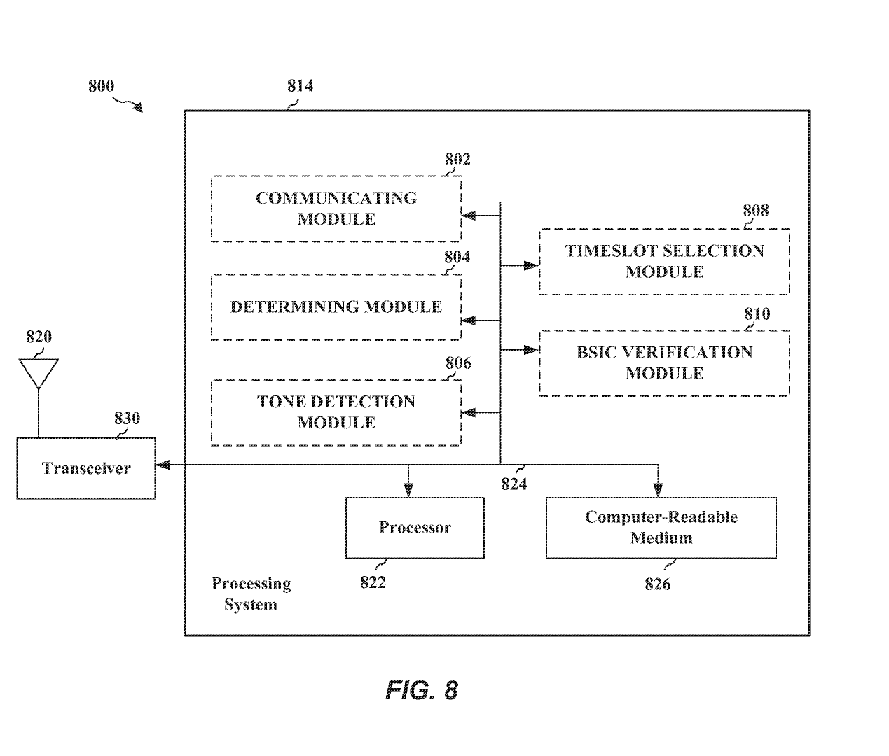

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, 806, 808, 810 and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

In one aspect, the processing system 814 includes a communicating module 802, determining module 804 and tone detection module 806. The communicating module 802 is for communicating with or on a first radio access technology (RAT). The determining module 804 determines whether a gap generated by an idle timeslot(s) is sufficient to perform tone detection but not sufficient to perform BSIC verification of a second rate. The tone detection module 806 halts performance of the tone detection of a second RAT when the gap is not sufficient to perform BSIC verification and the signal quality of the serving cell of the first RAT is above a first threshold value.

In another aspect, the processing system 814 includes a communicating module 802, determining module 804, tone detection module 806, timeslot selection module 808 and BSIC verification module 810. The communicating module 802 communicates on a first RAT and may halt communication with the first RAT during selected timeslots. The determining module 804 determines whether tone detection may be performed in a gap generated by an idle timeslot(s). The tone detection module 806 may perform tone detection when the gap is not sufficient to perform BSIC verification and when the signal quality of the serving cell of the first RAT is below a first threshold value. The timeslot selection module 808 selects timeslots. The BSIC verification module 810 performs BSIC verification of the second RAT during selected timeslots. The modules may be software modules running in the processor 822, resident/stored in the computer readable medium 826, one or more hardware modules coupled to the processor 822, or some combination thereof. The processing system 814 may be a component of the UE 350 and may include the memory 392, and/or the controller/processor 390.

In one configuration, an apparatus such as a UE is configured for wireless communication including means for communicating. In one aspect, the communicating means may be the antennas 352, the receiver 354, the channel processor 394, the receive frame processor 360, the receive processor 370, the transmitter 356, the transmit frame processor 382, the transmit processor 380, the controller/processor 390, and/or the memory 392 configured to perform the communicating means. The UE is also configured to include means for determining. In one aspect, the determining means may be the controller/processor 390 and/or the memory 392 configured to perform the determining means. The UE is also configured to include means for performing/halting tone detection. In one aspect, the tone detection performing means may be the antennas 352, the receiver 354, the channel processor 394, the receive frame processor 360, the receive processor 370, the controller/processor 390, and/or the memory 392, configured to perform the tone detection performing/halting means. The UE may also be configured to include a means for selecting timeslots. In one aspect, the selecting means may be the controller/processor 390 and/or the memory 392 configured to perform the selecting means. The UE is also configured to including means for performing BSIC verification. In one aspect the BSIC verification performing means may include the controller/processor 390 and/or the memory 392 configured to perform the BSIC verification performing means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
communicating on a first radio access technology (RAT);
determining whether a gap generated by at least one idle timeslot in the first RAT communication is sufficient to perform tone detection but not sufficient to perform base station identity code (BSIC) verification of a second RAT; and
halting performance of tone detection of the second RAT when the gap is not sufficient to perform BSIC verification and a signal quality of a serving cell of the first RAT is above a first threshold value.

2. The method of claim 1, in which the signal quality comprises signal strength.

3. The method of claim 1, in which the first RAT is time division-synchronous code division multiple access (TD-SCDMA) and the second RAT is global system for mobile communications (GSM).

4. The method of claim 1, in which tone detection comprises frequency correction channel (FCCH) tone detection.

5. A method of wireless communication, comprising:
communicating on a first radio access technology (RAT);
determining whether a gap generated by at least one idle timeslot in the first RAT communication is sufficient to perform tone detection but not sufficient to perform base station identity code (BSIC) verification of a second RAT;
performing tone detection to locate a signal from the second RAT for BSIC verification when the gap is not sufficient to perform BSIC verification and when a signal quality of a serving cell of the first RAT is below a first threshold value;
selecting timeslots of the first RAT based on a timing of the signal from the second RAT for BSIC verification;
halting communication with the first RAT during the selected timeslots; and
performing BSIC verification of the second RAT during the selected timeslots.

6. The method of claim 5, in which the signal quality comprises signal strength.

7. The method of claim 5, in which the first RAT is time division-synchronous code division multiple access (TD-SCDMA) and the second RAT is global system for mobile communications (GSM).

8. The method of claim 5, in which tone detection comprises frequency correction channel (FCCH) tone detection.

9. An apparatus for wireless communication, comprising:
a memory; and
at least one processor coupled to the memory, the at least one processor being configured:
to communicate on a first radio access technology (RAT);
to determine whether a gap generated by at least one idle timeslot in the first RAT communication is sufficient to perform tone detection but not sufficient to perform base station identity code (BSIC) verification of a second RAT; and
to halt performance of tone detection of the second RAT when the gap is not sufficient to perform BSIC verification and a signal quality of a serving cell of the first RAT is above a first threshold value.

10. The apparatus of claim 9, in which the signal quality comprises signal strength.

11. The apparatus of claim 9, in which the first RAT is time division-synchronous code division multiple access (TD-SCDMA) and the second RAT is global system for mobile communications (GSM).

12. The apparatus of claim 9, in which tone detection comprises frequency correction channel (FCCH) tone detection.

13. An apparatus for wireless communication, comprising:
a memory; and
at least one processor coupled to the memory, the at least one processor being configured:
to communicate on a first radio access technology (RAT);
to determine whether a gap generated by at least one idle timeslot in the first RAT communication is sufficient to perform tone detection but not sufficient to perform base station identity code (BSIC) verification of a second RAT;
to perform tone detection to locate a signal from the second RAT for BSIC verification when the gap is not sufficient to perform BSIC verification and when a signal quality of a serving cell of the first RAT is below a first threshold value;
to select timeslots of the first RAT based on a timing of the signal from the second RAT for BSIC verification;
to halt communication with the first RAT during the selected timeslots; and
to perform BSIC verification of the second RAT during the selected timeslots.

14. The method of claim 13, in which the signal quality comprises signal strength.

15. The method of claim 13, in which the first RAT is time division-synchronous code division multiple access (TD-SCDMA) and the second RAT is global system for mobile communications (GSM).

16. The method of claim 13, in which tone detection comprises frequency correction channel (FCCH) tone detection.

17. A computer program product for wireless communication in a wireless network, comprising:
a non-transitory computer-readable medium having non-transitory program code recorded thereon, the program code comprising:
program code to communicate on a first radio access technology (RAT);
program code to determine whether a gap generated by at least one idle timeslot in the first RAT communication is sufficient to perform tone detection but not sufficient to perform base station identity code (BSIC) verification of a second RAT; and
program code to halt performance of tone detection of the second RAT when the gap is not sufficient to perform BSIC verification and a signal quality of the serving cell of the first RAT is above a first threshold value.

18. A computer program product for wireless communication in a wireless network, comprising:
a non-transitory computer-readable medium having non-transitory program code recorded thereon, the program code comprising:
program code to communicate on a first radio access technology (RAT);
program code to determine whether a gap generated by at least one idle timeslot in the first RAT communication is sufficient to perform tone detection but not sufficient to perform base station identity code (BSIC) verification of a second RAT;
program code to perform tone detection to locate a signal from the second RAT for BSIC verification when the gap is not sufficient to perform BSIC verification and when a signal quality of a serving cell of the first RAT is below a first threshold value;
program code to select timeslots of the first RAT based on a timing of the signal from the second RAT for BSIC verification;
program code to halt communication with the first RAT during the selected timeslots; and
program code to perform BSIC verification of the second RAT during the selected timeslots.

19. An apparatus for wireless communication, comprising:
means for communicating on a first radio access technology (RAT);
means for determining whether a gap generated by at least one idle timeslot in the first RAT communication is sufficient to perform tone detection but not sufficient to perform base station identity code (BSIC) verification of a second RAT; and
means for halting performance of tone detection of the second RAT when the gap is not sufficient to perform BSIC verification and a signal quality of the serving cell of the first RAT is above a first threshold value.

20. An apparatus for wireless communication, comprising:
means for communicating on a first radio access technology (RAT);
means for determining whether a gap generated by at least one idle timeslot in the first RAT communication is sufficient to perform tone detection but not sufficient to perform base station identity code (BSIC) verification of a second RAT;
means for performing tone detection to locate a signal from the second RAT for BSIC verification when the gap is not sufficient to perform BSIC verification and when a signal quality of a serving cell of the first RAT is below a first threshold value;
means for selecting timeslots of the first RAT based on a timing of the signal from the second RAT for BSIC verification;
means for halting communication with the first RAT during the selected timeslots; and
means for performing BSIC verification of the second RAT during the selected timeslots.
